(19) United States
(12) Patent Application Publication
(10) Pub. No.: US 2024/0074477 A1
(43) Pub. Date: Mar. 7, 2024

(54) VEGETARIAN SAUSAGES

(71) Applicant: DSM IP ASSETS B.V., Heerlen (NL)

(72) Inventors: Rudan YA, Tongxiang (CN); Fei ZHANG, Shanghai (CN); Chienkuo YUAN, Shanghai (CN)

(21) Appl. No.: 18/261,881

(22) PCT Filed: Jan. 21, 2022
(86) PCT No.: PCT/EP2022/051304

§ 371 Date: Jul. 18, 2023

(30) Foreign Application Priority Data
Jan. 22, 2021 (WO) PCT/CN2021/073293
Jan. 26, 2021 (EP) 21153374.0

(51) Int. Cl. A23L 29/269; A23J 3/16; A23J 3/22

(52) U.S. Cl. CPC A23L 29/272; A23J 3/16; A23J 3/227

(57) ABSTRACT

The invention relates to a vegetarian emulsified meat product, comprising: 20 to 80 wt. % water; 1 to 20 wt. % rapeseed protein comprising cruciferins and/or napins; 1 to 20 wt. % texturized vegetable protein; 1 to 20 wt. % oil; 0.1 to 5 wt. % gellan gum; and 0 to 10 wt. % colorants and flavours.

### FIELD OF THE INVENTION

The invention relates to a vegetarian emulsified meat product. Further the present invention relates to a method for producing the vegetarian emulsified meat product. Finally, the present invention relates to the use of the vegetarian emulsified meat product.

### BACKGROUND OF THE INVENTION

Proteins are an essential element in animal and human nutrition. Meat, in the form of animal flesh and fish, are the most common sources of high protein food. The many disadvantages associated with the use of animal-derived protein for human consumption, ranging from acceptability of raising animals for consumption to the fact that such meat production is inefficient in terms of feed input to food output and carbon foot print, makes the ongoing search for improved meat alternatives one of the most active developments in present day society.

Historically, meat alternatives achieve a certain protein content using vegetable sources such as soy (e.g. tofu, tempeh) or gluten/wheat (e.g. seitan). Today, modern techniques are used to make meat alternatives with more meat-like texture, flavor and appearance. Soy and gluten are favorable sources for such meat alternatives because they are widely available, affordable, relatively high in protein and well processable. Producers of meat alternatives turn to other proteins, for example like those derived from legumes, e.g. pea. However, use of these alternative protein sources is accompanied with new problems. The protein mixtures are often not as easily processible as the traditional soy or gluten or their combinations, and in many cases also lead to texturized food proteins that do not mimic the nutrition, texture, appearance, and/or the taste of animal-derived meat products. As a result, consumers typically consider such meat alternatives unappealing and unpalatable. Hence, there is a need in the art for meat alternatives that are appealing and palatable. More specifically there is a need in the art for vegetarian emulsified meat type products having texture and appearance that closely mimic the texture of emulsified meat products. It is especially challenging to provide animal protein free emulsified meat type products that have a good hardness and cohesion.

A commonly used hydrocolloid used in meat alternatives is methyl cellulose. Methyl cellulose is undesired in view of the food label requirements requiring mentioning of such chemical. Consumers more and more desire clean label food products.

WO2019/120982 relates to shaped vegetarian casing-less smoked sausages comprising water, oil, protein and herbs and spices. Sausages are produced using a protein mix of wheat protein and egg protein.

WO2019/120960 relates to a shaped vegetarian meat product comprising water, oil, protein, containing at least 4 vol. % of oil droplets having an equivalent spherical diameter in the range of 100 micrometer to 1,000 micrometer. Sausages and patties are produced using a protein mix of wheat protein and egg protein or with soy protein.

The disadvantage of wheat protein is that it comprises wheat gluten, which is allergenic. The disadvantage of egg protein is that it is allergenic. Further, the disadvantage of egg protein is that the produced food item is not vegan. Still further, the texture of soy protein sausages lacks the hardness, cohesion and springiness of real meat-based products.

Thus, there is a need for alternatives of clean label hydrocolloids and functional and nutritional, non-allergenic proteins to make vegetarian or vegan emulsified meat products.

### DETAILED DESCRIPTION OF THE INVENTION

In the context of the invention, the term “vegetarian meat product” refers to meat analogue, meat alternative, meat substitute, mock meat, faux meat, imitation meat, vegetarian meat, fake meat, or vegan meat, and has texture, flavor, appearance or chemical characteristics of specific types of meat. Generally, a vegetarian meat product or a meat alternative refers to food made from vegetarian ingredients, and sometimes without animal products such as dairy or egg, such as vegan. Vegan means without any animal protein.

The term emulsified meat product as used herein refers to products consisting of a cooked and comminuted matrix.

Gellan gum is a microbially-produced polysaccharide which can be produced by strains of the species Sphingomonas elodea. Gellan gum is usually produced as an extracellular product by cultivation of the microorganisms in a medium containing appropriate carbon sources, phosphate sources, nitrogen sources, and suitable trace elements. The fermentation can be carried out under sterile conditions with proper aeration, agitation, temperature and pH. When the fermentation is accomplished, the produced fermentation broth is processed to recover the gum. Gellan gum can be recovered in several ways. Direct recovery from the fermentation broth yields gellan gum in its native or high acyl (HA) form. Recovery after deacylation yields gellan gum in its low acyl (LA) form. It should be understood that the phrases “native gellan gum” and “high acyl gellan gum” may be used interchangeably to describe the same gellan gum herein and throughout this disclosure.

In a first aspect, the present invention relates to a vegetarian emulsified meat product, or a meat substitute, comprising:
(i) 20 to 80 wt. % water;
(ii) 1 to 20 wt. % rapeseed protein, preferably comprising napins and/or cruciferins; preferably wherein the 1 to 20 wt. % rapeseed protein is not part of the texturized vegetable protein;
(iii) 1 to 20 wt. % texturized vegetable protein;
(iv) 1 to 20 wt. % oil;
(v) 0.1 to 5 wt. % gellan gum; and/or
(vi) 0 to 10 wt. % colorants and flavours. Preferably the amounts of ingredients do not exceed 100 wt. % of the vegetarian emulsified meat product. Preferably the present vegetarian emulsified meat product is a vegan emulsified meat product.

The present inventors found that, without wishing to be bound to any theory, the combination of rapeseed protein and gellan gum provides a texture that closely mimics the texture of real meat emulsified type products.

The rapeseed protein may be in the form of an isolate or a concentrate. Rapeseed protein isolate may be prepared from cold-pressed rapeseed oil seed meal as described in WO 2018/007492 resulting in a product with a protein content of from 50-98% (w/w), or from 70-95% (w/w) or of 90±5% (w/w). The rapeseed protein isolate may comprise of from 40-65% (w/w) cruciferins and of from 35-60% (w/w) napins as verified by Blue Native PAGE, for example as described in WO 2018/007492.

In an embodiment, the present rapeseed protein is a rapeseed protein isolate, preferably having an amount of protein of at least 90 wt. % (calculated as Kjeldahl N×6.25) on a dry weight basis.

Alternatively, the present rapeseed protein is a rapeseed protein powder, or is not texturized rapeseed protein.

The rapeseed used to obtain the rapeseed protein isolate as applied in the instant invention is usually of the varieties Brassica napus or Brassica rapa or Brassica juncea. These varieties contain low levels of erucic acid and glucosinolates, and are the source of canola oil, a generic term for rapeseed oil comprising less than 2% erucic acid and less than 30 mmol/g glucosinolates. The predominant storage proteins found in rapeseed are cruciferins and napins. Cruciferins are globulins and are the major storage protein in the seed. A cruciferin is composed of 6 subunits and has a total molecular weight of approximately 300 kDa. Napins are albumins and are low molecular weight storage proteins with a molecular weight of approximately 14 kDa. Napins are more easily solubilized and are primarily proposed for use in applications where solubility is key. Rapeseed proteins can also be divided into various fractions according to the corresponding sedimentation coefficient in Svedberg units (S). This coefficient indicates the speed of sedimentation of a macromolecule in a centrifugal field. For rapeseed proteins, the main reported fractions are 12S, 7S and 2S. Napin is a 2S albumin, and cruciferin is a 12S globulin. In the context of the present invention, the rapeseed protein isolate comprises from 15 to 65% (w/w) cruciferins and from 35 to 85% (w/w) napins, the total being equal to or less than 100%, and has a solubility of at least 88% when measured over a pH range from 3 to 10 at a temperature of 23±2° C.

In an embodiment, the present rapeseed protein comprises napins and/or cruciferins. More preferably the present rapeseed protein comprises napins and cruciferins.

In an embodiment, the present vegetarian emulsified meat product comprises a ratio, on weight basis, of cruciferin to napin in the range of from 1 cruciferin to 0.5 napin to 1 cruciferin to 1.5 napin. Alternatively, the present composition comprises a ratio of cruciferin to napin of at least 9 cruciferin to 1 napin or comprising a ratio of cruciferin to napin of 1 cruciferin to at least 9 napin.

In one embodiment the rapeseed protein comprises 40-65% (w/w) cruciferins and 35-60% (w/w) napins, or comprises 80-100% (w/w) cruciferins and 0-20% (w/w) napins, or comprises 0-20% (w/w) cruciferins and 80-100% (w/w) napins. Preferably wherein the sum of cruciferins and napins is not exceeding 100% (w/w) of the rapeseed protein.

In a preferred embodiment, the present rapeseed protein (isolate) comprises 40 to 65 wt. % cruciferins and 35 to 60 wt. % napins (of the rapeseed protein). Preferably, the present rapeseed protein comprises 40 to 55 wt. % cruciferins and 45 to 60 wt. % napins.

In a preferred embodiment, the present rapeseed protein (isolate) comprises 60 to 80 wt. % cruciferins and 20 to 40 wt. % napins. Preferably, the present rapeseed protein comprises 65 to 75 wt. % cruciferins and 25 to 35 wt. % napins.

In a preferred embodiment, the present rapeseed protein (isolate) comprises 0 to 10 wt. % cruciferins and 90 to 100 wt. % napins. Preferably, the present rapeseed protein comprises 1 to 5 wt. % cruciferins and 95 to 100 wt. % napins.

Preferably, the amounts of cruciferins and napins are determined by size exclusion chromatography (SEC). Preferably, the amounts of cruciferins and napins are determined by size exclusion chromatography (SEC) using the following test:
samples of protein isolate are dissolved in a 500 mM NaCl saline solution and analyzed by High Performance SEC using the same solution as the mobile phase, followed by detection using measuring UV absorbance at 280 nm, wherein the relative contribution of cruciferin and napin (wt. %) was calculated as the ratio of the peak area of each protein with respect to the sum of both peak areas.

Preferably, the present rapeseed protein (isolate) comprises 40 to 65 wt. % 12S and 35 to 60 wt. % 2S. Preferably, the present rapeseed protein comprises 40 to 55 wt. % 12S and 45 to 60 wt. % 2S.

In a preferred embodiment, the present rapeseed protein (isolate) comprises 60 to 80 wt. % 12S and 20 to 40 wt. % 2S. Preferably, the present rapeseed protein comprises 65 to 75 wt. % 12S and 25 to 35 wt. % 2S.

In a preferred embodiment, the present rapeseed protein (isolate) comprises 0 to 10 wt. % 12S and 90 to 100 wt. % 2S. Preferably, the present rapeseed protein comprises 1 to 5 wt. % 12S and 95 to 100 wt. % 2S.

Preferably, the amounts of 12S and 2S is determined by sedimentation velocity analytical ultracentrifugation (SV-AUC) analysis. Preferably, the amounts of 12S and 2S is determined by sedimentation velocity analytical ultracentrifugation (SV-AUC) analysis using the following test:
samples of protein isolate are dissolved in a 3.0% (or 500 mM) NaCl saline solution and amounts determined using interference optics.

In an embodiment the rapeseed protein is low in anti-nutritional factors and contains less than 5% (w/w) phytate, less than 4% (w/w) phytate, less than 3% (w/w) phyate, less than 2% (w/w) phyate, less than 1.5% (w/w) phytate, preferably less than 0.5% (w/w) phytate, and is low in glucosinolates (<5 μmol/g) and low in phenolics (<10 mg/g). In an embodiment the rapeseed protein has a high solubility of at least 88% when measured over a pH range from 3 to 10. In an embodiment the rapeseed protein has a low mineral content, in particular low in sodium, and with that a low conductivity when dissolved in water. This is advantageous as minimizing salt content in food products, i.e. also in meat alternatives, is an important topic in addressing improvement of public health. A well-known legume-derived protein isolate like pea protein isolate has a sodium load that is relatively high. In contrast, rapeseed protein may have a conductivity in a 2 wt. % aqueous solution of less than 9 mS/cm over a pH range of 2 to 12, for example of from 0.5-9 mS/cm, or from 1-7 mS/cm or 4±3 mS/cm.

In an embodiment, the present vegetarian emulsified meat product comprises an amount of rapeseed protein within the range of 2 to 15 wt. %, preferably 3 to 13 wt. %, more preferably 4 to 10 wt. %, most preferably 5 to 10 wt. %, of the vegetarian emulsified meat product. Preferably the present vegetarian emulsified meat product does not comprise hydrolyzed rapeseed protein.

In an embodiment, the present vegetarian emulsified meat product also comprises one or more other non-animal proteins like pea protein, fava bean protein, lentil protein, soybean protein, mungbean protein, or combinations thereof. Other proteins may be used may be for instance derived from lupin, pea (yellow pea, green pea), bean (such as kidney bean, green bean, haricot bean, pinto bean, adzuki bean), chickpea, lupin, tree nuts (cashew, peanut, almond), algae (chlorella, spirulina, RuBisCo), potato, green leaves (RuBisCo). The protein maybe be added in the form of an isolate and/or concentrate. In an embodiment, the present vegetarian emulsified meat product comprises an amount of second protein within the range of 0.1 to 12 wt. %, preferably 1 to 10 wt. %, more preferably 4 to 10 wt. %, most preferably 5 to 10 wt. %, of the vegetarian emulsified meat product.

In an embodiment, the vegetarian emulsified meat product does not comprise gluten or gliadin, i.e. the vegetarian emulsified meat product is so called gluten free. By gluten free is meant that the vegetarian emulsified meat product comprises less than 20 ppm of gluten and more preferably less than 10 ppm of gluten. Gluten is usually measured by measuring the gliadin content, for example as described in WO 2017/102535. Therefore, according to the present invention there is provided a gluten free vegetarian emulsified meat product comprising less than 10 ppm gliadin.

In an embodiment, the balance (to 100% w/w) of the remaining ingredients in the present vegetarian emulsified meat product may be water, preferably the balance is water. More preferably, the present vegetarian emulsified meat product comprises an amount of water up to 100% (w/w) of the vegetarian emulsified meat product. Preferably, the present vegetarian emulsified meat product comprises an amount of water of 40-75% (w/w) of the vegetarian emulsified meat product, more preferably of 50-70% (w/w) of the vegetarian emulsified meat product.

In a preferred embodiment the present gellan gum is high acyl gellan gum. Preferably the high acyl gellan gum is a polymer comprising various monosaccharides linked together to form a linear primary structure and the gum gels at temperatures of greater than 60 degrees centigrade. In some high acyl gellan gums, the gel temperature may be approximately 70 degrees centigrade or greater. In some high acyl gellan gums, the gel temperature may be approximately between 70 degrees centigrade and 80 degrees centigrade The properties of the high acyl gellan gum polymer may vary depending at least in part on its source, how it was processed, and/or the number and type of acyl groups present on the polymer.

Preferably, the amount of gellan gum in the present vegetarian emulsified meat product is within the range of 0.5 to 4 wt. %, preferably 1 to 3 wt. %, more preferably 1.5 to 2.5 wt. % of the vegetarian emulsified meat product.

Preferably, the present gellan gum, or the present high acyl gellan gum, has a single gel setting temperature that is within the range of 70° C. to 90° C. The advantage of high acyl gellan gum is that it forms soft and flexible gels, beneficial in providing a good texture of a vegetarian emulsified meat product, without introducing off flavors to the product.

Preferably, the present gellan gum, or the present high acyl gellan gum, has more than 40% acetyl and more than 45% glyceryl residual substitutions per repeating unit.

In an embodiment the present vegetarian emulsified meat product is a sausage, a smoked sausage, a frankfurter, a patty, hotdog, mortadella, pate or is a wiener. Particularly preferred is that the present vegetarian emulsified meat product is a sausage, or a vegetarian sausage. The present inventors found that plant-based or vegan sausages are provided that have an improved texture, i.e. an increased hardness, cohesiveness and springiness when compared to sausages comprising only soy as protein source. The present sausage may comprise a casing or may be casing less. Preferably the present sausage or present vegetarian emulsified meat product is casing less. Due to the advantageous texture of the product, it can be commercialized as a casing-less product.

Texture of the vegetarian emulsified meat products can be evaluated by e.g. hardness, cohesiveness and springiness, wherein hardness refers to the maximum force during the first bite (or the first compression), cohesiveness refers to the rate at which the vegetarian sausage disintegrates under mechanical force. In other words, cohesiveness is how well the product withstands a second deformation relative to its resistance under the first deformation. Cohesiveness can be measured as is the area of work during a second compression divided by the area or work during the first compression, in percentages or in ratio. Springiness refers to the height that the vegetarian emulsified meat product recovers during the time that elapses between the end of the first bite (first compression) and the start of the second bite (second compression). In other words, “Springiness is how well a product physically springs back after it has been deformed during the first compression and has been allowed to wait for the target wait time between strokes. The springback is usually measured at the down-stroke of the second compression.”

In an embodiment, texture analysis of the present vegetarian emulsified meat product can by performed by using TPA (Texture Profile Analysis) method by texture analyser (e.g. TA.XT.plus, SMS® weight range: up to 10 kg). In an embodiment, the TPA measurement can be performed by a double compression with settings of probe P/100, strain 40%, pre-test speed 1 mm/sec, test speed 1 mm/sec, and post-test speed 1 mm/sec. Reference is made to https://texturetechnologies.com/resources/texture-profile-analysis.

In an embodiment, the present vegetarian emulsified meat product has a hardness of more than 2000 g as measured with texture profile analysis, preferably wherein probe is P/100, strain is 40%, pre-test speed is 1 mm/sec, test speed is 1 mm/sec and post-test speed is 1 mm/sec, preferably using a sample diameter of 2.5 to 3 cm and/or a sample height of 2 cm. More preferably the hardness is within the range of 2000 to 4000 g, preferably 2500 to 3500 g, more preferably 2700 to 3000 g, as measured with texture profile analysis, preferably wherein a double compression probe is P/100, strain is 40%, pre-test speed is 1 mm/sec, test speed is 1 mm/sec and post-test speed is 1 mm/, preferably using a sample diameter of 2.5 to 3 cm and/or a sample height of 2 cm.

In an embodiment, the present vegetarian emulsified meat product has a springiness of more than 75% as measured with texture profile analysis, preferably wherein a double compression probe is P/100, strain is 40%, pre-test speed is 1 mm/sec, test speed is 1 mm/sec and post-test speed is 1 mm/sec, and preferably the time between the two compressions is 5 seconds. More preferably, a springiness of more than 80%, more than 85%, more than 90% or more than 95%. More preferably using a sample diameter of 2.5 to 3 cm and/or a sample height of 2 cm.

In an embodiment, the present vegetarian emulsified meat product has a cohesiveness wherein the product has a cohesion of more than 50% as measured with texture profile analysis, preferably wherein a double compression probe is P/100, strain is 40%, pre-test speed is 1 mm/sec, test speed is 1 mm/sec and post-test speed is 1 mm/sec and preferably wherein the time between the two compressions is 5 seconds. More preferably a cohesion of more than 55%, more than 60%, or within the range of 50 to 80%, such as within the range of 55 to 70% or within the range of 60 to 65%. Preferably using a sample diameter of 2.5 to 3 cm and/or a sample height of 2 cm.

In an embodiment, the vegetarian emulsified meat product comprises an amount of texturized vegetable protein (TVP) within the range of 2 to 15 wt. %, preferably 4 to 13 wt. %, more preferably 6 to 11 wt. % of the vegetarian emulsified meat product. Preferably wherein the texturized vegetable protein is not hydrated. The amounts of texturized vegetable protein as wt. % of the vegetarian emulsified meat product is the dry weight of the texturized vegetable protein.

In an embodiment, the vegetarian emulsified meat product comprises an amount of hydrated texturized vegetable protein (TVP) within the range of 5 to 40 wt. %, preferably 10 to 30 wt. %, more preferably 15 to 25 wt. % of the vegetarian emulsified meat product.

The term “textured or texturized vegetable protein” as used herein refers to a product obtained by extrusion, having a fibrous and/or spongy matrix, and is based on plant extracted material, preferably derived from legumes, cereals (preferably gluten free such as oat fiber, maize fiber, rice fiber) or oilseeds. For example, the legume may be soy or pea. The oilseeds can be sunflower or canola seeds. In one embodiment, the textured vegetable protein is made by extrusion. This can cause a change in the structure of the protein which results in a fibrous, spongy matrix, similar in texture to meat. The textured vegetable protein can be dehydrated or non-dehydrated. Preferably, the present texturized vegetable protein does not comprise rapeseed protein.

In an embodiment, the present texturized vegetable protein comprises pea protein, fava protein, lentil protein, soybean protein, rapeseed protein, wheat protein, rice protein or combinations thereof. Preferably, the texturized vegetable protein comprises texturized soy protein. Other legume-derived proteins may be used for the present texturized vegetable protein, for instance lupin, pea (yellow pea, green pea), bean (such as faba bean, kidney bean, green bean, haricot bean, pinto bean, mung bean, adzuki bean), chickpea, lupin, lentil, soy and peanut, and the like.

Fibers may be added to the present vegetarian emulsified meat product to improve the texture and firmness and consistency, and/or to improve the nutritional value of the material and/or as a filler. Examples of plant-based fiber are pea fiber, oil seed fiber (such as sunflower seed fiber or cotton seed fiber), fruit fiber (such as apple fiber, pumpkin fiber), cereal fiber (such as oat fiber, maize fiber, rice fiber), bamboo fiber, potato fiber, inulin, or combinations thereof, Fibers are commonly present in plant-based foods and cannot (completely) be broken down by the human digestive enzymes, are either soluble or insoluble fibers (soluble in water). Fiber fractions are materials that also can comprise protein, starch, and/or ash. Preferably, the present vegetarian emulsified meat product comprises fiber or starch in an amount of 1 to 15 wt. %, preferably in an amount of 5 to 10 wt. % of the vegetarian emulsified meat product. The starch can be native, motive or pregelatinized starch. The starch can be from wheat, corn, tapioca, potato or faba bean.

In an embodiment, the amount of oil is within the range of 2 to 18 wt. %, preferably 5 to 15 wt. %, more preferably 7 to 12 wt. % of the vegetarian emulsified meat product.

The present oil can be an algal oil, a fungal oil, corn oil, olive oil, soybean oil, peanut oil, walnut oil, almond oil, sesame oil, cottonseed oil, rapeseed oil, canola oil, safflower oil, sunflower oil, flax seed oil, palm oil, palm kernel oil, coconut oil, babassu oil, shea butter, mango butter, cocoa butter, borage oil, black currant oil, sea-buckhorn oil, macadamia oil, saw palmetto oil, conjugated linoleic oil, arachidonic acid enriched oil, docosahexaenoic acid (DHA) enriched oil, eicosapentaenoic acid (EPA) enriched oil, palm stearic acid, or rice bran oil; or margarine or other hydrogenated fats. Preferably the oil is rapeseed oil or sunflower oil or soybean oil.

The present vegetarian emulsified meat product may comprise a binder, preferably 0.01 to 5 wt. % of a binder, more preferably 0.1 to 2 wt. % of the vegetarian emulsified meat product.

The term “binder” or “binding agent” as used herein relates to a substance for holding together particles and/or fibres in a cohesive mass. It is an edible substance that in the final product is used to trap components of the foodstuff with a matrix for the purpose of forming a cohesive product and/or for thickening the product. Binding agents of the invention may contribute to a smoother product texture, add body to a product, help retain moisture and/or assist in maintaining cohesive product shape; for example by aiding particles to agglomerate.

The binder can be an isolated plant protein (e.g., a RuBisCO, an albumin, a conglycinin, or mixtures thereof). The denaturation temperature of the binder can be between about 40 degrees centigrade and about 80 degrees centigrade. The binder can be a carbohydrate or derivative. The carbohydrate can contain methylcellulose or hydroxypropylmethyl cellulose. The binder may comprise amounts of methylcellulose. It is desired that the amount of methylcellulose is reduced if compared to benchmark products. In an embodiment, the amount of methylcellulose is within the range of 0.01 wt % to 2 wt. % of the emulsified meat product. Preferably within the range of 0.1 wt. % to 1.0 wt. % of the emulsified meat product. Preferably the present vegetarian emulsified meat product does not comprise methylcellulose.

In another embodiment, the present binder comprises 0.1 wt to 10 wt % potato fibre and 0.3 wt % to 10 wt % plant protein, and wherein not less than 30 wt % of the dietary fibre is soluble.

In a preferred embodiment, the amount of colorants and flavours is within the range of 0.01 to 10 wt. %, more preferably 0.1 to 8 w. %, most preferably 0.5 to 6 wt. % of the vegetarian emulsified meat product. Preferably, the amount of colorants and flavours is expressed as wt. % on dry matter of the emulsified meat product.

In a preferred embodiment, the present colorant comprises or is beet root or beet root powder. The advantage of using beet root is that a meaty like color is provided to the product, without introducing off flavors to the product.

The present colorant can also be or comprise a carotenoid. Preferably, the carotenoid is chosen from the group consisting of α- or β-carotene, 8′-apo-β-carotenal, 8′-apo-β-carotenoic acid esters such as the ethyl ester, canthaxanthin, astaxanthin, astaxanthin esters, lycopene, lutein, zeaxanthin or crocetin and their derivatives.

The present colorant can also be or comprise a heme, a heme protein or a (macro)molecule with complexed iron. More preferably the present vegetarian emulsified meat product comprises 0.001 to 5% (w/w) of a heme, a heme protein or a (macro)molecule with complexed iron.

In a preferred embodiment the present vegetarian emulsified meat product comprises a flavor or flavor agent, or flavor precursor. More preferably the present meat analogue product comprises 0.001 to 5% (w/w) of a flavor. Preferably, the present flavours comprise yeast extracts or process flavours.

In an embodiment the present vegetarian emulsified meat product comprises a flavour masker, flavour modifier or a flavouring with modifying properties. More preferably the present meat analogue product comprises 0.001 to 1% (w/w) of a flavour masker, flavour modifier or a flavouring with modifying properties.

In a preferred embodiment, the present vegetarian emulsified meat product comprises vitamins and/or minerals, preferably vitamins chosen from the group consisting of B2, B3, B6 and B12 and/or preferably minerals chosen from the group consisting of iron, selenium and zinc. The advantage of adding these nutrients is that the present vegetarian emulsified meat product more closely resembles the nutritional value of a real meat, without introducing off flavors to the vegetarian emulsified meat product.

In a second aspect the invention provides a method for producing the present vegetarian emulsified meat product, comprising the steps of mixing the ingredients until a homogenous dough is obtained and optionally compressing the homogenous dough in a (vegan) casing.

In an embodiment, the present method comprises steps of hydrating the texturized vegetable protein and/or the rapeseed protein.

In an embodiment, the present method further comprises a step of cooking the homogenous dough or the cased homogenous dough at a temperature of at least 90° C. for a time period of 1 to 300 minutes. Preferably at a temperature of at least 90° C. for a time period of 1 to 300 minutes wherein the interior of the homogenous dough reaches a temperature of at least 90° C., preferably at least 95° C., more preferably at least 100° C. Preferably, the present method further comprises a step of cooking the homogenous dough or the cased homogenous dough at a temperature of at least 100 or 110° C. for a time period of 1 to 300 minutes, such as from 10 to 100 minutes.

In an embodiment, the present method further comprises freezing the vegetarian emulsified meat product, or the cooked vegetarian emulsified meat product, to provide a frozen vegetarian emulsified meat product. A frozen form is advantageous in that the storage time of the product is increased, and can be consumed after thawing to provide a still homogeneous product that did not suffer from freeze damage.

In a third aspect, the present invention relates to the use of the present vegetarian emulsified meat product as a food item.

In a fourth aspect, the present invention relates to the use of rapeseed protein isolate for providing texture, hardness and/or cohesion in a vegetarian emulsified meat product. Preferably wherein the rapeseed protein is as disclosed herein. Preferably wherein the vegetarian emulsified meat product is as disclosed herein. Preferably wherein the vegetarian emulsified meat product comprises:
(i) 20 to 80 wt. % water;
(ii) 1 to 20 wt. % rapeseed protein (isolate);
(iii) 1 to 20 wt. % texturized vegetable protein;
(iv) 1 to 20 wt. % oil;
(v) 0.1 to 5 wt. % gellan gum; and/or
(vi) 0 to 10 wt. % colorants and flavours.

The invention is further illustrated in the following non limiting examples.

### EXAMPLES

### Materials and Methods

### Materials

Rapeseed protein isolate (RPI) was prepared from cold-pressed rapeseed oil seed meal as described in WO 2018/007492; the protein content was 90% (w/w). The resultant RPI comprised in the range of from 40 to 65% (w/w) cruciferins and 35 to 60% (w/w) napins, contained less than 0.26% (w/w) phytate and had a solubility of at least 88% when measured over a pH range from 3 to 10 at a temperature of 23±2° C. pH measurements were carried out using a Radiometer model PHM220 pH meter equipped with a PHC3085-8 Calomel Combined pH electrode (D=5MM).

Soy texturized vegetable protein was obtained from Hung Yang Foods. Binding agents comprised methyl cellulose obtained from JRS and GellaneerHD™ high acyl gellan gum obtained from DSM. Rapeseed oil (Jinlongyu©, Yihai Kerry), modified starch (Ingredion), coloring and flavours comprised red pigment (MR haematochrome 390SPWS from SENSIENT) and yeast extract (obtained from DSM). Further, meat flavor (RH15111 from Firmenich), black pepper, fennel powder, coriander powder and garlic powder were resourced from local market. Sausage casing was obtained from Shuanghui Group.

### Measurement of Texture of Vegetarian Sausage

Texture analysis of vegetarian sausage was performed using TPA (Texture Profile Analysis) method by texture analyser (TA.XT.plus, SMS®). Hardness, cohesiveness and springiness were incorporated in the analysis results, where hardness refers to the maximum force during the first bite, cohesiveness refers to the rate at which the vegetarian sausage disintegrates under mechanical force and springiness refers to the height that the vegetarian sausage recovers during the time that elapses between the end of the first bite and the start of the second bite.

The measurement settings were as follows: a double compression using probe P/100, strain 40%, pre-test speed 1 mm/sec, test speed 1 mm/sec, post-test speed 1 mm/sec, 5 second pause between double compression.

### Example 1

Preparation of Vegetarian Sausages with Rapeseed Protein

The soy textured vegetable protein (10 g) was soaked in water (10 g) for 30 minutes and placed in a cutter mixer (Thermomix from Vorwerk®) equipped with a cutter blade and heating system. Textured vegetable protein was minced into fine particles (5 mm-17 mm) in the cutter mixer at stirring speed type 9 for 10 minutes to obtain the hydrated soy textured vegetable protein (TVP).

Methyl cellulose (0.6 g) and water (1.8 g) or methyl cellulose (0.6 g) and gellan gum (1.8 g) were dispersed in deionized water (35 g) in a plastic cup to let the mixture absorb water to obtain binding mixture.

Deionized water (50 g) was added in a stainless-steel cup (cup volume 500 ml) and deionized water was stirred by a four-blade agitator (RW20 digital from IKA®) at 2000 rpm. Rapeseed protein isolate or soybean protein isolate (10 g) was added into water followed by slowly adding rapeseed oil (90 g) into the protein solution. This protein emulsion was continuously stirred for 5 minutes for the sake of full emulsification of rapeseed or soy protein. 15 g protein emulsion was taken out for further use.

TABLE 1

| | control without | Test 1 | Test 2 |
|---|---|---|---|
| | gellan gum and | Soybean | Rapeseed |
| Ingredient | without protein | protein isolate | protein isolate |
| (in grams) | isolate | and gellan gum | and gellan gum |
| Hydrated TVP | 20 | 20 | 20 |
| Binding mixture | 37.4 | 37.4 | 37.4 |
| Soybean protein | 15 | 15 | 0 |
| emulsion | | | |
| Rapeseed protein | 0 | 0 | 15 |
| emulsion | | | |
| water | 9 | 0 | 0 |
| Soybean protein | 0 | 9 | 0 |
| isolate | | | |
| Rapeseed protein | 0 | 0 | 9 |
| isolate | | | |
| Rapeseed oil | 5 | 5 | 5 |
| Starch | 6 | 6 | 6 |
| Yeast extract | 2 | 2 | 2 |
| Meat flavour | 1 | 1 | 1 |
| Fennel powder | 1 | 1 | 1 |
| Coriander powder | 1 | 1 | 1 |
| Black pepper | 0.5 | 0.5 | 0.5 |
| Garlic powder | 0.5 | 0.5 | 0.5 |
| Red pigment | 1.6 | 1.6 | 1.6 |
| solution | | | |

Other ingredients including rapeseed oil (5 g), rapeseed protein (9 g), starch (6 g), yeast extract (2 g), meat flavour (1 g), fennel powder (1 g), coriander powder 5 (1 g), black pepper (0.5 g) and garlic powder (0.5 g) were then fully mixed with the hydrated soy textured vegetable protein (20 g), binding mixture (37.4 g) and the 15 g protein emulsion. The red pigment (1.6 g) was dissolved in 98.4 g deionized water, and then 1.6 g pigment solution was added into the mixture. Water was added to complete to 100 g.

The mixture was kneaded evenly into a patty, and subsequently placed in the refrigerator at 4° C. for 1 hour before using. After cooling, the patty was compressed into a plastic sausage casing with a width of 34 mm and both ends of the casing were tied tightly to form a sausage. The sausage was placed in the steamer of cutter mixer setting temperature at 110° C. to ensure the core temperature of the sausage reaching 95° C. and heated the sausage for 15 minutes. When steaming was done, the sausage was cooled down to room temperature (25° C.), then the casing was peeled off to obtain the cooked vegetarian sausage.

The cooked vegetarian sausage has almost the same appearance and taste as those of a conventional commercially available meat sausage.

As control, the vegetarian sausage was prepared by following the same recipe and process but without adding gellan gum, which was replaced with the same weight of water.

Compared to the control, the vegetarian sausage comprising rapeseed protein and gellan gum has improved texture such as smoother cutting surface, higher hardness, higher springiness. The comparison result is shown in Table 2.

TABLE 2
comparison of the vegetarian sausages

| | Control | Test 1 | Test 2 |
|---|---|---|---|
| Hardness, grams | 673 | 1572 | 2801 |
| Cohesion, % | 37.8 | 47.3 | 62.5 |
| Springiness, % | 57.2 | 73.3 | 84.8 |

It can be seen that rapeseed protein and gellan gum has achieved synergistic effect by enhancing firmness and springiness of vegetarian sausage, and also imparting chewy and elastic mouthfeel, compared to the reference with an equal amount of soybean protein. It is surprising that canola protein gives a better structure than soy protein. Without wishing to be bound by any theory, it is expected that canola protein functions as a binder, more than soy protein.

1. A vegetarian emulsified meat product, comprising:
(i) 20 to 80 wt. % water;
(ii) 1 to 20 wt. % rapeseed protein comprising napins and/or cruciferins;
(iii) 1 to 20 wt. % texturized vegetable protein;
(iv) 1 to 20 wt. % oil;
(v) 0.1 to 5 wt. % gellan gum; and
(vi) 0 to 10 wt. % colorants and flavors.

2. The vegetarian emulsified meat product according to claim 1, wherein the gellan gum is high acyl gellan gum.

3. The vegetarian emulsified meat product according to claim 1, wherein the rapeseed protein is a rapeseed protein isolate, optionally having an amount of protein of at least 90 wt. % (calculated as Kjeldahl N×6.25) on a dry weight basis.

4. The vegetarian emulsified meat product according to claim 1, wherein the rapeseed protein comprises 40 to 65 wt. % cruciferins and 35 to 60 wt. % napins.

5. The vegetarian emulsified meat product according to claim 1, comprising a ratio of cruciferin to napin in a range of from 1 cruciferin to 0.5 napin to 1 cruciferin to 1.5 napin, comprising a ratio of cruciferin to napin of at least 9 cruciferin to 1 napin or comprising a ratio of cruciferin to napin of 1 cruciferin to at least 9 napin.

6. The vegetarian emulsified meat product according to claim 1, wherein the rapeseed protein comprises 60 to 80 wt. % cruciferins and 20 to 40 wt. % napins.

7. The vegetarian emulsified meat product according to claim 1, wherein the rapeseed protein comprises 0 to 10 wt. % cruciferins and 90 to 100 wt. % napins.

8. The vegetarian emulsified meat product according to claim 1, wherein the product is a sausage, a smoked sausage, a frankfurter, a patty, hotdog, mortadella, pate or is a wiener.

9. The vegetarian emulsified meat product according to claim 1, wherein the texturized vegetable protein comprises pea protein, fava protein, lentil protein, soy bean protein, rapeseed protein, wheat protein, rice protein, or combinations thereof.

10. The vegetarian emulsified meat product according to claim 1, wherein the product has a hardness of more than 2000 g as measured with texture profile analysis, optionally wherein probe is P/100, strain is 40%, pre-test speed is 1 mm/sec, test speed is 1 mm/sec and post-test speed is 1 mm/sec, optionally using a sample diameter of 2.5 to 3 cm and a sample height of 2 cm.

11. The vegetarian emulsified meat product according to claim 1, wherein the product has a springiness of more than 75% as measured with texture profile analysis, optionally using a double compression wherein probe is P/100, strain is 40%, pre-test speed is 1 mm/sec, test speed is 1 mm/sec and post-test speed is 1 mm/sec and the time between the two compressions is 5 seconds.

12. The vegetarian emulsified meat product according to claim 1, wherein the product has a cohesiveness of more than 50% as measured with texture profile analysis, optionally using a double compression wherein probe is P/100, strain is 40%, pre-test speed is 1 mm/sec, test speed is 1 mm/sec and post-test speed is 1 mm/sec and the time between the two compressions is 5 seconds.

13. A method for producing a vegetarian emulsified meat product as defined in claim 1, comprising mixing ingredients until a homogenous dough is obtained and optionally compressing the homogenous dough in a casing.

14. The method according to claim 13, further comprising cooking the optionally cased homogenous dough at a temperature of at least 90 C.° for a time period of 1 to 300 minutes, optionally further comprising freezing the vegetarian emulsified meat product to provide a frozen vegetarian emulsified meat product.

15. A food item comprising the vegetarian emulsified meat product as defined in claim 1.

16. A rapeseed protein isolate for providing texture, hardness and/or cohesion in a vegetarian emulsified meat product.
